(19) United States
(12) Patent Application Publication
(10) Pub. No.: US 2012/0167050 A1
(43) Pub. Date: Jun. 28, 2012

(54) PRODUCT TEST SYSTEM AND PRODUCT TEST METHOD

(75) Inventors: SHIH-FANG WONG, Tu-Cheng (TW); XIN LU, Shenzhen City (CN); FEI WANG, Shenzhen City (CN); YAO-HUA LIU, Shenzhen City (CN); HUI-FENG LIU, Shenzhen City (CN); HUAN-HUAN ZHANG, Shenzhen City (CN); XUE-SHUN LIU, Shenzhen City (CN); YU-KAI XIONG, Shenzhen City (CN); BIAO-GENG ZHONG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/111,973

(22) Filed: May 20, 2011

(30) Foreign Application Priority Data
Dec. 25, 2010 (CN) 201010606850.8

(51) Int. Cl. G06F 9/44

(52) U.S. Cl. 717/124

(57) ABSTRACT

A product test system and method are provided. The test terminal opens a test webpage and is connected to a server through a network. The test terminal transmits a workstation name and a product identification code entered into the test terminal through the test webpage to the server. The server determines a test software name corresponding to the workstation name and the product identification code, and runs a test software corresponding to the determined test software name to provide a test interface on the test terminal. The test terminal tests a product corresponding to the entered production identification code by using the test interface.

### BACKGROUND

1. Technical Field

The present disclosure relates to a product test system and a product test method.

2. Description of Related Art

Product line may consist of a number of workstations. Many workstations may have a test terminal such as a computer requiring the installation of a variety of test software to test products. As the test software is installed on the test terminal, problems may arise due to operator error. What is needed is a way to avoid human error in the installation and use of the test software.

### BRIEF DESCRIPTION OF THE DRAWINGS

The components of the drawings are not necessarily drawn to scale, the emphasis instead being placed upon clearly illustrating the principles of a product test system and a product test method. Moreover, in the drawings, like reference numerals designate corresponding parts throughout several views.

FIG. 1 is a block diagram of a product test system in accordance with an exemplary embodiment.

FIG. 2 is a flowchart of a product test method in accordance with an exemplary embodiment.

### DETAILED DESCRIPTION

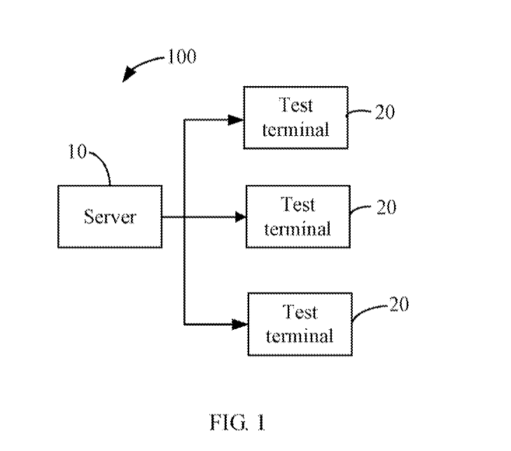

Referring to FIG. 1, a product test system 100 includes a server 10 and at least one test terminal 20 capable of being connected to the server 10. The test terminal 20 is used to test products.

The server 10 stores a variety of test software and a table. As shown below, the table records a number of workstation names, at least one product identification code corresponding to each workstation name, and a test software name corresponding to each product identification code. Each workstation has one test terminal 20.

TABLE

| Workstation name | Product ID | Test software name |
|---|---|---|
| 1 | ID1 | Name1 |
| | ID2 | Name2 |
| 2 | ID3 | Name3 |
| . . . | . . . | . . . |

To test a product at one workstation, the test terminal 20 of the workstation opens a test webpage in response to operator input. The test webpage includes a login window for an operator to enter a correct user name and password. When the correct user name and password are entered, the test terminal 20 can be connected to the server 10 through a network such as the Internet. After the test terminal 20 is connected to the server 10, the workstation name and the product identification code corresponding to the to-be-tested product are entered into the test terminal 20 through the test webpage and further transmitted to the server 10 by the test terminal 20. The server 10 searches in the table to determine the test software name corresponding to the workstation name and the product identification code, and runs the test software corresponding to the determined test software name to provide a test interface on the test terminal 20. The test terminal 20 tests the to-be-tested product by using the test interface. The test terminal 20 further records test results and transmits the test results to the server 10 to backup the test results.

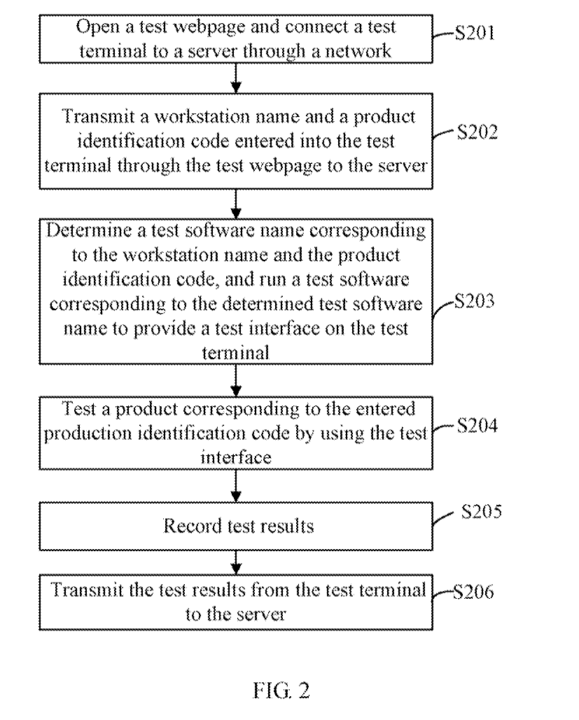

FIG. 2 is a flowchart of a product test method in accordance with an exemplary embodiment.

In step S201, the test terminal 20 opens the test webpage and is connected to the server 10 through the network. In this embodiment, the test webpage includes a login window for the operator to enter a correct user name and password. When the correct user name and password are entered, the test terminal 20 can be connected to the server 10 through the network.

In step S202, the test terminal 20 transmits a workstation name and a product identification code entered into the test terminal 20 through the test webpage to the server 10.

In step S203, the server 10 searches in the table to determine the test software name corresponding to the workstation name and the product identification code and runs the test software corresponding to the determined test software name to provide the test interface on the test terminal 20.

In step S204, the test terminal 20 tests a product corresponding to the product identification code by using the test interface.

In step S205, the test terminal 20 records test results.

In step S206, the test terminal 20 transmits the test results to the server 10 to backup the test results.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A product test system, comprising:
a server storing a variety of test software and a table, the table recording a plurality of workstation names, at least one product identification code corresponding to each of the plurality of the workstation names, and a test software name corresponding to each product identification code; and
a test terminal to open a test webpage in response to operator input and connected to the server through a network, and further transmit a workstation name and a product identification code entered into the test terminal through the test webpage to the server;
wherein, the server searches in the table to determine the test software name corresponding to the workstation name and the product identification received from the test terminal, and runs the test software corresponding to the determined test software name to provide a test interface on the test terminal, the test terminal tests a product corresponding to the entered product identification code by using the test interface.

2. The product test system as described in claim 1, wherein the test webpage comprises a login window, the test terminal is connected to the server through a network when a correct user name and a correct password are entered into the login window.

3. The product test system as described in claim 1, wherein the test terminal further records test results.

4. The product test system as described in claim 3, wherein the test terminal further transmits the test results to the server.

5. A product test method applied in a product test system, the product test system comprising a server and a test terminal, the server storing a variety of test software and a table, the table recording a plurality of workstation names, at least one product identification corresponding to each of the plurality of the workstation names, and a test software name corresponding to each product identification code, the method comprising:
opening a test webpage and connecting the test terminal to the server through a network;
transmitting a workstation name and a product identification code entered into the test terminal through the test webpage to the server;
searching in the table to determine the test software name corresponding to the workstation name and the product identification code, and running the test software corresponding to the determined test software name to provide a test interface on the test terminal; and
testing a product corresponding to the input production identification code by using the test interface displayed on the test terminal.

6. The method as described in claim 5, wherein the test webpage comprises a login window, the test terminal is connected to the server through the network when a correct user name and a correct password is entered into the login window.

7. The method as described in claim 5, further comprising:
recording test results; and
transmitting the test results from the test terminal to the server.
